(19) United States
(12) Patent Application Publication
(10) Pub. No.: US 2007/0035069 A1
(43) Pub. Date: Feb. 15, 2007

(54) Method for the manufacture of a three-dimensional molding

(76) Inventors: Frank Peter Wust, Herrenberg (DE); Michael Schmid, Grobenzell (DE)

Correspondence Address: KRIEGSMAN & KRIEGSMAN, 30 TURNPIKE ROAD, SUITE 9, SOUTHBOROUGH, MA, 01772, US

(21) Appl. No.: 11/452,131

(22) Filed: Jun. 13, 2006

(30) Foreign Application Priority Data
Jun. 13, 2005 (DE) 102005027311 - 4

(51) Int. Cl. B29C 35/08

(52) U.S. Cl. 264/497; 264/113

(57) ABSTRACT

The invention relates to a method for the manufacture of a three-dimensional molding (29), wherein the molding (29) is generated from a solidifiable powder material by consecutively solidifying individual layers through the effect of radiation (27), while generating a new layer by exposing traces that are arranged adjacent to each other to radiation, wherein, in order to form an overhang region (47), a contour trace (49) is formed on a coherently solidified region and on a powder material (17) that has not solidified yet, the contour trace (49) is adjusted to an outer contour at least in the region of transition from the solidified region to the powder material (17) that has not solidified yet, and the at least one further contour trace (49′) adjusted to the outer contour is formed of non-solidified material (17) while comprising a high overlapping degree in relation to the previously formed contour trace (49).

### BACKGROUND OF THE INVENTION

The invention relates to a method for the manufacture of a three-dimensional molding, wherein the molding is generated from a solidifiable powder material by consecutively solidifying individual layers through the effect of radiation, e.g. laser radiation.

DE 43 09 524 C2 has disclosed a method for the manufacture of a three-dimensional molding wherein each layer is disintegrated in an inner core region and an outer enveloping region. The radiation strategies selected in the core region and the enveloping region are differing in order to generate different properties of either region. The radiation in the core region is such that the deformation of the object during and after solidification is at a minimum, whereas the radiation in the enveloping region is provided for generating as smooth and precise a surface as possible. To achieve this, the enveloping region is defined by subtracting individual regions of the core region from the overall body in a three-dimensional manner.

DE 100 42 132 A1 discloses a method for the manufacture of a three-dimensional molding, which is based on the aforementioned method wherein each layer is disintegrated in an inner core region and an outer enveloping region and the radiation strategies selected in the core region and the enveloping region are differing in order to generate different properties of either region. However, this method suggests to dimension the radiation at least in the enveloping region such that the molding, after having been completed, comprises a surface layer in which the powder material has been fused completely. To achieve this, use is made of a radiation strategy where the energy is brought into the outer enveloping region or inner core region of each layer in individual sections, wherein the single sections are spaced apart from each other by a distance which is greater than or at least equal to the mean diameter of said single sections. The single sections are exposed to radiation one after the other in stochastic distribution. This is intended to achieve manufacture of a layer with minimum deformation. This type of radiation is also known as tile or chessboard radiation.

A further known radiation strategy is crosshatched radiation wherein radiation is effected by exposing traces that are arranged next to each other to radiation in a line-type or column-type manner. The subsequent peripheral laser beam traversing of the outer workpiece contour or of inner free surfaces in the marginal region is intended to achieve a uniform surface of the component.

DE 101 12 591 A1 also discloses a method for the manufacture of a three-dimensional molding of liquid or powder material. Therein, a radiation strategy is suggested where the beam, starting at an initial contour line, generates a plurality of contours on the layer, said contours neighboring each other while overlapping each other to a minor degree and interlocking each other in the manner of onion rings. This type of radiation is known as onion radiation. This manufacture of the layer is intended to reduce the tendency to form cracklines extending across the area regions exposed to radiation. According to a surface contour of the coherent region to be built, the initial contour line can extend from without inward or from within outward.

Onion radiation, which starts with an initial contour line corresponding to the edge contour of the layer to be built, is to disadvantage in that, through the transitions from powder material to solidified material, stresses are built up despite an adjustment of laser beam parameters. The same applies to starting the initial contour line according to the principle of onion radiation within the region to be exposed to radiation, wherein contour lines are formed that are arranged adjacent to each other in an outward direction. These adjacent contour lines are each based on the preceding contour line and are formed to be adjusted to the outermost contour line, wherein the contour of an overhang region is not taken into consideration.

### SUMMARY OF THE INVENTION

For that reason, the invention aims at creating a method for the manufacture of a three-dimensional molding, facilitating a non-deforming manufacture of overhang regions of a three-dimensional molding.

This problem is solved according to the invention by means of the elements of Claim 1. Further advantageous executive forms are specified in the further claims.

The method according to the invention, which is based on overhang radiation true to contours, enables the manufacture of an overhang region with at least minimum stress and minimum deformation. The overhang region is arranged adjacent to a region that has already solidified in a coherent manner. A first contour trace following the outer contour of the overhang region is placed at the transition from the already coherently solidified region to the overhang region. The first contour trace of the overhang region is made irrespective of the radiation strategies used beforehand. The contour traces are built up in the free material powder and have a high degree of overlapping in relation to the already solidified region. The placement of one or more contour traces next to each other in a contour-adjusted manner in order to produce an overhang region ensures that the layer to be solidified is homogeneous and also enables filigree structures.

According to an advantageous embodiment of the method, it is provided that the beam for the production of the contour trace is directed onto material that has not solidified yet, with an overlapping degree of at least 50 percent of the trace width in relation to the preceding contour trace, or to the already coherently solidified region. The high degree of overlapping allows diminishing of internal stresses, because an essential part of the previously built contour trace that has already solidified or of the already coherently solidified region is fused once again.

According to a further advantageous embodiment of the method, it is provided that the coherently solidified region is formed by a core region, an outer contour region or both regions.

According to a further advantageous embodiment of the method, it is provided that the layer to be built from powder material is subdivided in a core region, an outer contour region and an overhang region, wherein a matching radiation strategy is allocated to each region. In the core region and the outer contour region, it is, for example, possible to select radiation strategies which solidify as large an area of the layer as possible in the core region within a short time, while generating a high surface quality of the molding in the outer contour region. In the overhang region, adjustment of the radiation strategy allows the development of a homogeneous transition, so that the risk of formation of cracks is reduced. As a result, the radiation strategy can be adjusted to individual regions for filigree structures, thereby producing fine-structure geometries. For example, crosshatched radiation or onion radiation can be used for the core region and the outer contour region, wherein the individual radiation strategies can also be mixed with each other within each of the regions. Irrespective of these radiation strategies in the core region and/or the outer contour region, the overhang radiation provided for the overhang region is true to contours, in order to allow uniform and homogeneous formation of the overhang region. This permits to achieve an improved surface composition and strength.

According to an alternative embodiment of the method, it is preferrably provided that the layer to be built from powder material is subdivided in a core region and an overhang region and that a radiation strategy is allocated to the particular region concerned. When adjusted to the requirements for the surface quality and geometry of the molding, this alternative strategy may be of advantage as compared with the aforementioned strategy. While a three-dimensional molding is made from a plurality of layers, a specific strategy can be selected for the particular layer to be formed from powder material, wherein the strategy for the layer to be formed can be changed after each single layer or after a plurality of layers produced with the same strategy.

According to a further advantageous embodiment of the invention, it is provided that the radiation strategy for any one region is selected irrespective of the radiation strategies in the further region. This allows to achieve a high flexibility in the manufacture of the three-dimensional molding which may comprise various regions with different qualities and structures in its composition.

### BRIEF DESCRIPTION OF THE DRAWINGS

Below, the invention as well as further advantageous executive forms and further developments thereof will be described and illustrated in more detail by means of the examples represented in the drawings. According to the invention, the elements disclosed in the description and the drawings can be used separately or in any combination and number desired. In the figures,

FIG. 1 is a schematic diagram of an apparatus for the manufacture of a molding according to the method according to the invention;

FIG. 2 is a perspective view of a segment of a molding according to FIG. 1;

FIG. 3 is an enlarged schematic diagram of a plurality of overhang regions formed one above the other;

FIG. 4 is a perspective view of contour traces of a cone-shaped molding.

### DETAILED DESCRIPTION OF PREFERRED EMBODIMENTS

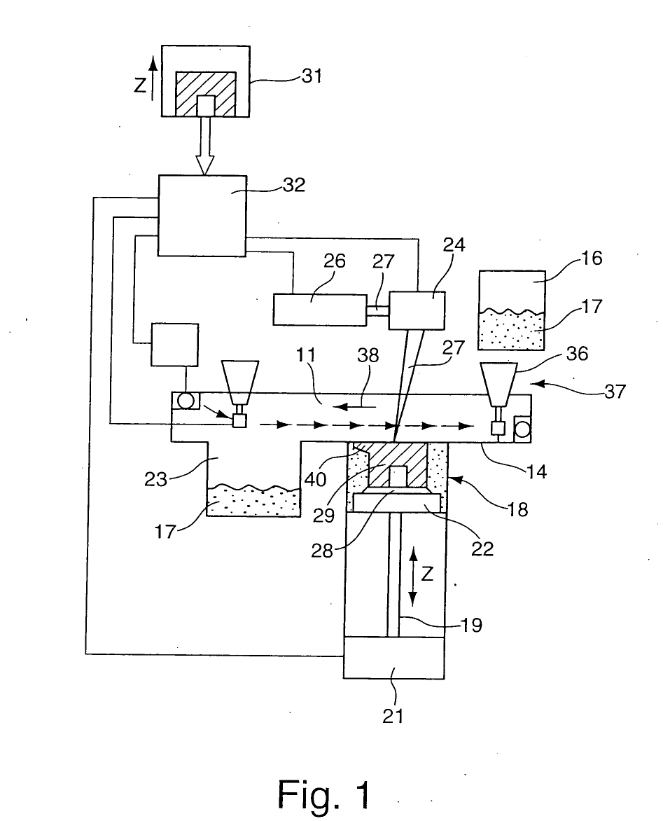

FIG. 1 shows an apparatus for generative processing with laser radiation, particularly for selective laser melting, such as described in DE 198 53 978 C1. This apparatus comprises a process chamber 11. A storage tank 16 which is filled with material powder 17 is provided above a bottom area 14 of the process chamber 11. The material powders used may, for example, be ferrous metals, such as steel; non-ferrous metals, such as titanium or aluminum; or other materials, such as composite materials or plastic materials. A build chamber 18 which accommodates a build platform 22 driven by a drive 21 via a lifting screw 19 ends in the bottom area 14 from below. A base plate 28 is arranged on the build platform 22 in a detachable manner, wherein a molding 29 is built on the base plate 28. A collection tank 23 for the material powder 17 is provided next to the build chamber 18. A displacement assembly 24 directing a laser beam 27 generated by a laser 26 onto the build platform 22 or base plate 28 is provided above the process chamber 11.

In order to produce a molding 29, for example a prototype of a component, the component coordinates are, in a first step, entered in a central processing unit 32 via an input unit 31. After the data has been processed appropriately, the build platform 22 is, in the build chamber 18, moved to a starting position where the build platform 22 and the base plate 28 are arranged below the level of the bottom area 14 according to a powder layer thickness to be applied. A predefined volume of material powder 17 is filled from the storage tank 16 into a receiving tank 36 of an application unit 37. To apply the material powder 17, the application unit 37 is moved in application direction 38 over the bottom area 14 and to the collection tank 23 at least once over the molding 29 to be built. After a predefined thickness of the powder layer has been applied, the laser 26 and the displacement assembly 24 are activated to direct the laser beam 27 onto the material powder 17 present above the build platform 22 and/or the base plate 28 and, according to component coordinates, to fuse that amount of powder that corresponds to the bottommost layer of the molding 29. After the bottommost layer of the molding 29 has been built, the build platform 22 is moved down by a defined distance, so that the upper side of the first layer is positioned below the level of the bottom area 14 of the process chamber 11. Thereafter, the application unit 37 is actuated again in order to apply a defined powder layer to the molding 29. The laser beam 27 will then be moved again over the powder layer trace by trace and according to component coordinates. This trace-wise movement for fusing the powder layer is, for example, described in more detail in DE 196 49 865 C1.

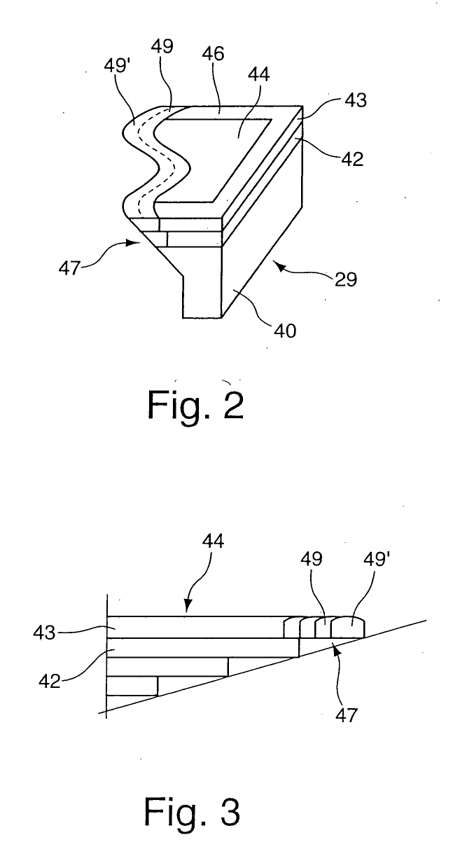

FIG. 2 is an enlarged view of a segment 40 of the molding 29 according to FIG. 1. The molding 29 is built from powder material, layer by layer. For example, the layers 42 and 43 shown are produced in this manner.

Preferably, the molding 29 to be treated is subdivided in two or three regions for each layer to be solidified, wherein a radiation strategy is allocated to each of these regions. Said subdivision in various regions is illustrated by the instance of the upper layer 43. The layer 43 consists of a core region 44 followed by an outer contour region 46 and, to the left, an overhang region 47. The sizes of the core region 44 and the outer contour region 46 depend on the component geometry and the particular coherent area extending in X-direction and Y-direction. These regions 44, 46 can also be defined through specified size parameters.

Identical or different radiation strategies can be selected for the core region 44 and the outer contour region 46. It is, for example, possible to select crosshatched radiation, chessboard radiation and/or onion radiation. Within the core region 44, it is also possible to combine different radiation strategies, for example chessboard radiation and crosshatched radiation.

A contour trace 49 following the outer contour of the overhang region 47 in the layer 43 is placed at the transition from the core region 44 to the overhang region 47. Therein, it is provided that the contour trace 49 is built up in the free powder and comprises an overlapping degree of at least 50 percent of the trace width in relation to the core region 44 that has already solidified. Thereafter, at least one further contour trace 49′ is placed, which is formed of a powder material that has not solidified yet and comprises a high overlapping degree in relation to the previously built contour trace 49 or 49′. The beam parameters for the manufacture of the contour traces 49, 49′, which extend along the outer contour of the molding 29 in the layer 43, are set to the overhang region 47 such that the scanning speed, the focusing and the incidence point of the laser beam 27 as well as the power of the laser 26 are adjusted to the layer thickness, the powder material and the surface quality required.

The overhang region(s) 47 is/are formed by a plurality of contour traces 49, 49′ which are placed one after the other and next to each other with an overlap while comprising a high overlapping degree, preferably in excess of 50 percent. The contour traces 49, 49′ can be placed such that they start from the core region 44, the outer contour region 46 or from either region 44, 46, in order to form an overhang region 47. It is understood that it is also possible to provide layers without any overhang region 47 between individual layers with an overhang region 47 or a plurality of layers with an overhang region 47. Such layers without any overhang region 47 can, for example, be subdivided in a core region 44 and an outer contour region 46 which are formed by means of known exposure strategies, such as chessboard radiation or onion radiation.

FIG. 3 shows a plurality of layers with overhang regions 47 where the overlapping region, as seen in relation to the vertical, assumes an angle in excess of 45 degrees. Where such slopes of the overhang region 47 are concerned, a plurality of contour traces 49, 49′ must be arranged next to each other and with an overlap, in order to form the overhang region 47. To achieve this, a radiation strategy can be provided, wherein the contour trace 49 is formed by moving the beam in one direction and the neighboring contour trace 49′ is formed by moving the beam in the opposite direction, etc. It can also be provided that the contour traces 49 and 49′ are applied in the same direction of movement. Irrespective of the radiation strategy, the contour traces 49, 49′ that are arranged adjacent to each other comprise a high overlapping degree, preferably in excess of 50 percent. The connection of the first contour trace 49 to the already solidified core region 44 and/or outer contour region 46 allows to prevent the overhang region 47 formed by the contour traces 49, 49′ from sinking into the powder bed.

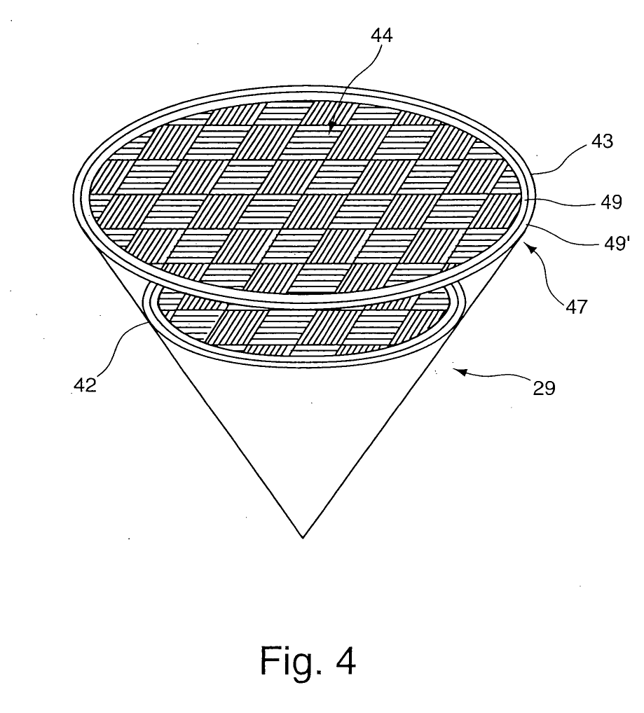

FIG. 4 shows a solid molding 29 the outer surface of which is formed by a conical surface. The outer contour of the molding 29 in the various layers is formed by circles wherein the diameter increases from bottom to top. Since the molding 29 is formed as a solid cone, the cross-sectional area to be exposed to radiation in a layer is a filled circular area. The illustrated instance shows the radiation strategies for a layer 42 in the center of the molding 29 and an upper layer 43.

The upper layer 43 consists of a core region 44 and an overhang region 47. Since the cone widens from bottom to top, the layer 43 comprises nothing but a core region 44 and an overhang region 47; there is no outer contour region.

The core region 44 is made through chessboard radiation combined with crosshatched radiation. The overhang region 47 that is formed by a plurality of contour traces 49 and 49′ is arranged adjacent to the outside of the core region 44. The contour traces 49, 49′ represent closed circular laser traces which are adjusted to the outer contour of the cone and comprise an overlapping degree of at least 50 percent in relation to the already solidified core region 44 or to the previously built contour trace 49, 49′.

What is claimed is:

1. A method for the manufacture of a three-dimensional molding, wherein the molding is generated from a solidifiable powder material by consecutively solidifying individual layers through the effect of radiation, wherein a new layer is produced by exposing traces that are arranged adjacent to each other to radiation, characterized in that
to achieve formation of an overhang region, a contour trace is formed on a coherently solidified region and on a powder material that has not solidified yet,
at least in the region of transition from the solidified region to the powder material that has not solidified yet, the contour trace is adjusted to an outer contour, and
the at least one further contour trace adjusted to the outer contour is formed of non-solidified material and comprises a high overlapping degree in relation to the previously formed contour trace.

2. A method according to claim 1, characterized in that the beam for making the contour trace on material that has not solidified yet is directed with an overlapping degree of at least 50 percent of the trace width in relation to the preceding contour trace or to the solidified region.

3. A method according to claim 1, characterized in that the coherently solidified region is formed by a core region, an outer contour region or both regions.

4. A method according to claim 1, characterized in that the layer to be formed of powder material is subdivided in a core region, an outer contour region and an overhang region and that a radiation strategy is allocated to the particular region concerned.

5. A method according to claim 4, characterized in that the radiation strategy for a region is selected independently of the radiation strategies in the further regions.

6. A method according to claim 1, characterized in that the layer to be formed of powder material is subdivided in a core region and an overhang region and that a radiation strategy is allocated to the particular region concerned.

7. A method according to claim 6, characterized in that the radiation strategy for a region is selected independently of the radiation strategies in the further regions.
